(19) United States
(12) Patent Application Publication
(10) Pub. No.: US 2008/0040738 A1
(43) Pub. Date: Feb. 14, 2008

(54) Content Reproduction Terminal

(76) Inventors: Ryuichi Okamoto, Osaka (JP); Masaya Yamamoto, Osaka (JP); Akio Higashi, Osaka (JP); Senichi Onoda, Osaka (JP); Katsumi Tokuda, Osaka (JP)

Correspondence Address: WENDEROTH, LIND & PONACK L.L.P., 2033 K. STREET, NW, SUITE 800, WASHINGTON, DC, 20006, US

(21) Appl. No.: 10/588,968

(22) PCT Filed: Mar. 28, 2005
(86) PCT No.: PCT/JP05/05753

§ 371 Date: Aug. 10, 2006

(30) Foreign Application Priority Data
Mar. 31, 2004 (JP) 2004-105857

(51) Int. Cl. H04N 7/16

(52) U.S. Cl. 725/25

(57) ABSTRACT

The present invention provides a content reproduction terminal which can be transformed between a general-purpose terminal and a members-only terminal.

A content reproduction terminal 30a is composed of: an IC card slot into which a card 20a distributed to a membership user is to be inserted; an application/display-data acquisition unit 304a which sets the operation mode on the basis of a membership certificate 2020 showing a group, to which the user belongs, held previously in the card 20a; and a resident player application execution unit 305a and a member player application execution unit 308a which reproduce the content differently depending on the setting result given by the application/display-data acquisition unit 304a.

### TECHNICAL FIELD

The present invention relates to a content reproduction technology for a DVD player or the like that reproduces content.

### BACKGROUND ART

In recent years, with the digitalization of content such as music and video, home appliance manufacturers have released content reproduction terminals for reproducing the content. Meanwhile, there is a move among content providers and content rental companies to provide content reproduction terminals which attract a user purchasing the content and a user renting the content by adopting membership systems that differentiate the terminals from others. For the members who signed up for particular service, such a content reproduction terminal performs special operations exclusively for the members to enhance the appearance of reproduction and to increase the ease of use.

Patent Reference 1: Japanese Application Publication No. 2004-171184

### DISCLOSURE OF INVENTION

Problems that Invention is to Solve

In the case of providing such a content reproduction terminal that performs the special operations exclusively for the members of the particular service, a members-only terminal needs to be separately manufactured. Moreover, although the appearance is enhanced and the ease of use is increased by the members-only terminal, it is complicated for the user because the user has to separately use various members-only terminals and a general-purpose terminal.

On account of this, the emergence of a content reproduction terminal, which can operate as a general-user terminal when the user is a general user (i.e., non-member) while operating as a dedicated terminal for particular service when the user is a member of the service (such as a member of a movie company A or member of a rental company B), is to be desired.

Hence, an object of the present invention is to solve the stated problem and to provide a content reproduction terminal which plays a double role as a general-purpose terminal and as a members-only terminal.

Means to Solve the Problems

In order to achieve the stated object, a content reproduction terminal of the present invention is a content reproduction terminal for reproducing content, that is composed of: a terminal body; and a secure device to be placed in the terminal body, wherein the secure device includes a membership information hold unit operable to hold membership information which is distributed to a membership user and indicates a group to which the user belongs, and the terminal body includes: an operation mode setting unit operable to set an operation mode on the basis of the membership information held by the membership information hold unit; and a reproduction unit operable to reproduce the content differently depending on the setting result given by the operation mode setting unit.

With this, it becomes possible to provide a content reproduction terminal which is capable of playing a double role as a general-purpose terminal and as a members-only terminal.

Moreover, according to the content reproduction terminal of the present invention, the reproduction unit may have: a first storage unit operable to store a first application program for reproducing the content in a members-only operation mode; a second storage unit operable to store a second application program for reproducing the content in a non-member operation mode; a selection unit operable to select one of the first application program and the second application program in accordance with the setting result; and an execution unit operable to execute the application program selected by the selection unit to reproduce the content, wherein the first application program may be operable to cause the execution unit to execute a members-only decorative display.

Thus, with the members-only decoration display, the terminal can be differentiated as a members-only terminal. Furthermore, according to the content reproduction terminal of the present invention, the first application program may be further operable to cause the execution unit to execute a members-only graphical user interface display.

Thus, with the members-only graphical user interface display, the terminal can be differentiated as a members-only terminal.

Moreover, according to the content reproduction terminal of the present invention, the reproduction unit may have a storage unit operable to store an application program for reproducing the content; a selection unit operable to select one of first display data and second display data in accordance with the setting result; and an execution unit operable to execute the application program to reproduce the content using the selected display data, wherein the first display data may be used for a members-only decorative display, and the second display data may be used for a non-member undecorative display.

With the members-only decoration display, the terminal can be easily differentiated as a members-only terminal.

Furthermore, according to the content reproduction terminal of the present invention, the first display data may further include a members-only graphical user interface data.

With the members-only graphical user interface display, the terminal can be easily differentiated as a members-only terminal.

Also, according to the content reproduction terminal of the present invention, the secure device may further include a first storage unit operable to store a first application program for reproducing the content in a members-only operation mode, and the reproduction unit may have: a second storage unit operable to store a second application program for reproducing the content in a non-member operation mode; a selection unit operable to select one of the first application program and the second application program in accordance with the setting result; and an execution unit operable to execute the application program selected by the selection unit to reproduce the content, wherein the first application program may be operable to cause the execution unit to execute a members-only decorative display.

With this, the content reproduction terminal does not need to download the first application program from an outside source, so that the structure of the content reproduction terminal can be simplified.

Moreover, according to the content reproduction terminal of the present invention, the terminal body may further include an operation mode inquiry unit operable to inquire of the secure device about which operation mode is to be selected, and the secure device may further include an operation mode instruction unit operable to, when the inquiry is received, decide the operation mode on the basis of the membership information and to instruct the terminal body to operate in the decided operation mode, wherein the operation mode setting unit may be operable to set the operation mode on the basis of the instruction as to the operation mode decided by the operation mode instruction unit.

Thus, the operation mode can be set with reliability.

Furthermore, according to the content reproduction terminal of the present invention, the membership information hold unit may be operable to hold a plurality of sets of membership information, and the operation mode instruction unit may be operable to, when the inquiry is received, decide the operation mode including a set of membership information that is to be prioritized out of the plurality of sets of membership information.

Also, according to the content reproduction terminal of the present invention, the inquiry may include content information regarding the content to be reproduced, and the operation mode instruction unit may be operable to, when the inquiry is received, decide the operation mode including the set of membership information to be prioritized out of the plurality of sets of membership information, on the basis of the content information included in the inquiry.

Moreover, according to the content reproduction terminal of the present invention, the terminal body may further include an operation mode inquiry unit operable to inquire of the secure device about which operation mode is to be selected, and the secure device may include: a membership point storage unit operable to store a membership point given to the user; a rule storage unit operable to store a rule as to a membership status granted to the user according to a value of the membership point; and an operation mode instruction unit operable to, when the inquiry is received, decide the operation mode and the membership status on the basis of the membership information, the membership point, and the rule, and to instruct the terminal body as to the decided operation mode and the decided membership status, wherein the operation mode setting unit may be operable to set he operation mode on the basis of the instruction as to the operation mode and the membership status decided by the operation mode instruction unit.

With this, even when the user is a member in the same group, the terminal can be differentiated as a members-only terminal depending on the membership status.

Furthermore, according to the content reproduction terminal of the present invention, the secure device may be an IC card, the terminal body may further include an IC card slot into which the IC card is to be inserted, and the operation mode setting unit may be operable to set the operation mode on the basis of an insertion state of the IC card with respect to the IC card slot.

With this, it also becomes possible to provide a content reproduction terminal which is capable of playing a double role.

It should be noted that the present invention can be realized not only as such a content reproduction terminal, but also as: a content reproduction method that has steps corresponding to the characteristic units provided in such a content reproduction terminal; and a program that causes a computer to execute these steps. Also, it should be understood that such a program can be distributed via a recording medium such as a CD-ROM, or via a transmission medium such as the Internet.

### EFFECTS OF THE INVENTION

As is clear from the above explanation, owing to the content reproduction terminal of the present invention, a members-only terminal does not need to be separately manufactured, and a general-purpose terminal and various members-only terminals do not need to be separately used. The user can use the content reproduction terminal as a members-only terminal by inserting a membership card into an IC card slot of the content reproduction terminal.

In this way, the present invention allows one terminal to be transformed between a general-purpose terminal and a members-only terminal according to the insertion and withdrawal of a card. Thus, the practical value of the present invention is extremely high today when content sale and rental is widespread and there is a move to make a differentiation through a dedicated terminal.

### BRIEF DESCRIPTION OF DRAWINGS

FIG. 1 is a diagram showing an entire structure of a certain membership system applied to a content reproduction terminal of a first embodiment.

FIG. 2 is a block diagram showing function structures of a card 20a and a content reproduction terminal 30a shown in FIG. 1.

FIG. 3 is a diagram showing a data structure of a membership certificate 2020.

FIG. 4 is a flowchart showing an operation of operation mode change processing performed between the content reproduction terminal 30a and the card 20a.

FIG. 5 is a flowchart showing a subroutine of operation mode decision processing (S14) shown in FIG. 4.

FIG. 6 is a diagram showing an example of a data structure of an operation mode instruction 70a.

FIG. 7 is a flowchart showing a subroutine of operation mode change processing (S19) shown in FIG. 4.

FIG. 8 is a block diagram showing function structures of a content reproduction terminal and a card of a second embodiment of the present invention.

FIG. 9 is a block diagram showing function structures of a content reproduction terminal and a card of a third embodiment of the present invention.

FIG. 10 is a block diagram showing function structures of a content reproduction terminal and a card of a fourth embodiment of the present invention.

FIG. 11 is a flowchart showing a subroutine of the operation mode decision processing (S14) shown in FIG. 4.

FIG. 12 is a diagram showing an example of a data structure of an operation mode instruction 70b.

FIG. 13 is a diagram showing an entire structure of a membership system applied to a content reproduction terminal of a fifth embodiment of the present invention.

FIG. 14 is a flowchart showing a subroutine of the operation mode decision processing (S14) shown in FIG. 4.

FIG. 15 is a diagram showing a structure in a case where a content reproduction terminal 30e is connected to a home server 80 or the like via a home LAN 61 at home.

FIG. 16 is a diagram showing an entire structure of a membership system applied to a content reproduction terminal of a sixth embodiment of the present invention.

FIG. 17 is a diagram showing a case where an IC chip 20e takes the place of the card, as a secure device.

### NUMERICAL REFERENCES

20a, 20b, 20c, 20d card

20e IC chip

30a, 30b, 30c, 30d, 30e content reproduction terminal

31 IC card slot

70a, 70b operation mode instruction

71 operation mode instruction identifier

72 operation mode

73 membership status

201, 301 communication unit

202 membership certificate data hold unit

203a, 203b operation mode decision unit

204 membership point management unit

205 status-decision/rule-storage unit

302 network communication unit

303 operation mode control unit

304a, 304b, 304c application/display-data acquisition unit

305a, 305b resident player application execution unit

306a, 306b resident player application storage unit

307 resident display data storage unit

308a, 308b member player application execution unit

309a, 309b member player application storage unit

310a, 310b member display data storage unit

311 content-reproduction/information-presentation unit

2020 membership certificate

2040 membership point

2050 rule

3060a, 3060b resident player application

3070 resident display data

3090a, 3090b member player application

3100a, 3100b member display data

Best Mode for Carrying Out the Invention

The following is a detailed description of embodiments of the present invention, with reference to the drawings.

### First Embodiment

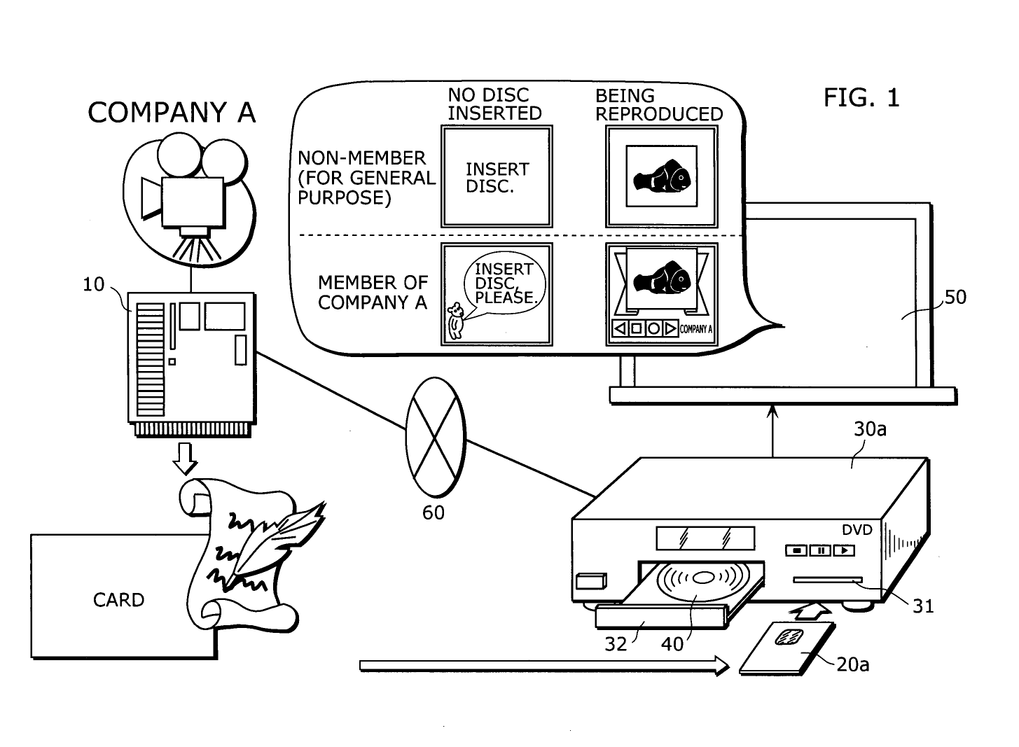

FIG. 1 is a diagram showing an entire structure of a certain membership system applied to a content reproduction terminal of the first embodiment.

A membership service provider (Company A, for example) of this membership system issues an IC card (also simply referred to as the “card” hereafter) 20a as a secure device to a user who signed up for the membership, using a server 10 after storing membership data into the card.

The user inserts the issued card 20a into a card slot 31 of a content reproduction terminal (also referred to as the “terminal body” hereafter) 30a as necessary.

The content reproduction terminal 30a inquires of the card 20a at a predetermined timing (such as when the terminal is activated or when the card is inserted or withdrawn) about which operation mode (a mode for a general-user terminal or for a members-only terminal of Company-A service, for example) should be selected.

The card 20a decides the operation mode on the basis of information inside the card (such as the presence or absence of the membership certificate and expiration date information), and sends the decided operation mode to the content reproduction terminal 30a.

The content reproduction terminal 30a operates in accordance with the result sent from the card 20a. The content reproduction terminal 30a is a DVD player, for example, which is composed of a tray 32 to set a DVD 40 in addition to the stated card slot 31 and is connected to the server 10 via a monitor 50 and a network 60 such as the Internet. In cases where the card 20a is not being inserted into the IC card slot 31, the content reproduction terminal 30a operates as a general-purpose terminal and simply displays a general message prompting for disc insertion when no disc is being inserted. When the disc is being reproduced, the content reproduction terminal 30a simply displays a general content reproduction screen and reproduces the content recorded in the DVD 40 (such as content called “Fishing Δ□×◯” that is about fishes and aimed at children).

Meanwhile, in cases where the card 20a of the membership in Company A is inserted into the IC card slot 31 and the membership certificate is valid, the content reproduction terminal 30a operates as a terminal dedicated to the members of Company A. When no disc is being inserted, the content reproduction terminal 30a has a message displayed prompting for disc insertion with decoration in such a way that a character of Company A (“Bear-the-◯□”, for example) is saying the message. When the disc is being reproduced, the content reproduction terminal 30a displays ribbons for the decoration around the frame of the content reproduction screen as well as displaying a GUI used for controlling the player.

It should be noted that a card provided with a storage medium such as an SD card may be used as the card 20a, instead of an IC card.

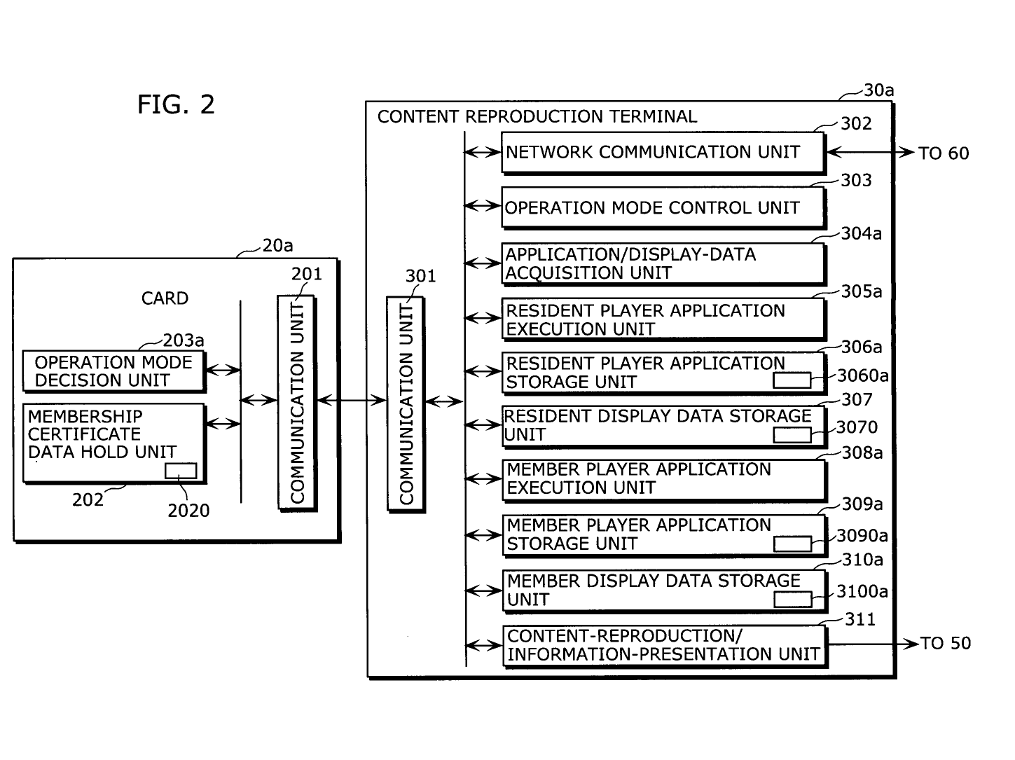

FIG. 2 is a block diagram showing function structures of the card 20a and the content reproduction terminal 30a shown in FIG. 1.

As shown in FIG. 2, the content reproduction terminal 30a is composed of a communication unit 301, a network communication unit 302, an operation mode control unit 303, an application/display-data acquisition unit 304a, a resident player application program execution unit 305a (hereafter, an application program may also be referred to as an “application”), a resident player application storage unit 306a, a resident display data storage unit 307, a member player application execution unit 308a, a member player application storage unit 309a, a member display data storage unit 310a, and a content-reproduction/information-presentation unit 311.

The communication unit 301 communicates with the card 20a inserted into the IC card slot 31.

The network communication unit 302 communicates with the server 10 via the network 60 and downloads a member application program held in the server 10 and member display data used by this member application program.

The operation mode control unit 303 detects whether or not the card 20a is being inserted into the IC card slot 31, sends an inquiry to the card 20a about the operation mode (referred to as the operation mode instruction request), and sets the operation mode in accordance with the operation mode instruction from the card 20a.

The resident player application storage unit 306a holds a resident player application 3060a that was stored prior to shipment of the terminal.

The resident display data storage unit 307 holds resident display data 3070 which was stored prior to shipment of the terminal and is to be used by the resident player application 3060a. It should be noted that the resident display data 3070 includes the message prompting for the disc insertion.

The resident player application execution unit 305a is realized by a CPU that executes the resident player application 3060a acquired by the application/display-data acquisition unit 304a.

The member player application storage unit 309a holds a member player application 3090a which is to be acquired after the shipment of the terminal. The acquisition method includes a download from the server 10 and a transfer from the card 20a.

The member display data storage unit 310a holds member display data 3100a which is to be acquired after the shipment of the terminal and used by the member player application 3090a. It should be noted that the member display data 3100a includes the message prompting for the disc insertion, a decorative display using a character, a decorative display employed during the content reproduction, and the GUI facilitating control of the player.

The member player application execution unit 308a is realized by a CPU that executes the member player application 3090a acquired by the application/display-data acquisition unit 304a.

The application/display-data acquisition unit 304a acquires a necessary application program and necessary display data from the corresponding storage units in accordance with the operation mode instruction. To be more specific, when the operation mode instruction indicates the general-purpose mode, the application/display-data acquisition unit 304a acquires the resident player application 3060a from the resident player application storage unit 306a and also acquires the resident display data 3070 to be used by the resident player application 3060a from the resident display data storage unit 307. When the operation mode instruction indicates the members-only mode, the application/display-data acquisition unit 304a acquires the member player application 3090a from the member player application storage unit 309a and also acquires the member display data 3100a to be used by the member player application 3090a from the member display data storage unit 310a.

The content-reproduction/information-presentation unit 311, which is shared between the resident units and the member units, actually reproduces content and presents information such as a song title or a title of the content.

Meanwhile, the card 20a is composed of a communication unit 201, a membership certificate data hold unit 202, and an operation mode decision unit 203a.

The communication unit 201 communicates with the content reproduction terminal 30a.

The membership certificate data hold unit 202 holds a membership certificate 2020.

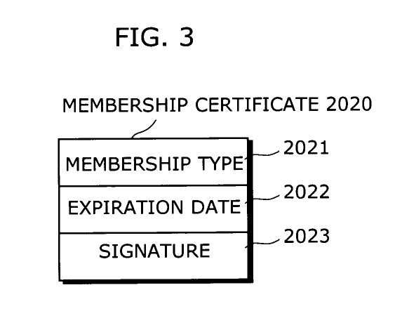

FIG. 3 is a diagram showing a data structure of the above-mentioned membership certificate 2020.

As shown in FIG. 3, the membership certificate 2020 is composed of a membership type 2021, an expiration date 2022, and a signature 2023.

The membership type 2021 indicates a group to which the user belongs (a member of Company A or a member of Company B, for example). The expiration date 2022 indicates an expiration date of the present membership certificate. The signature 2023 is data that is used for verifying correctness (validity) so as to prevent falsification of the membership type 2021 and the expiration date 2022.

When the operation mode instruction request is received from the content reproduction terminal 30a via the communication unit 201, the operation mode decision unit 203a decides whether to operate as the general-purpose terminal or as the members-only terminal and sends the operation mode instruction showing the decision result to the content reproduction terminal 30a via the communication unit 201.

Next, an explanation is given as to the operation mode change processing performed between the content reproduction terminal 30a and the card 20a.

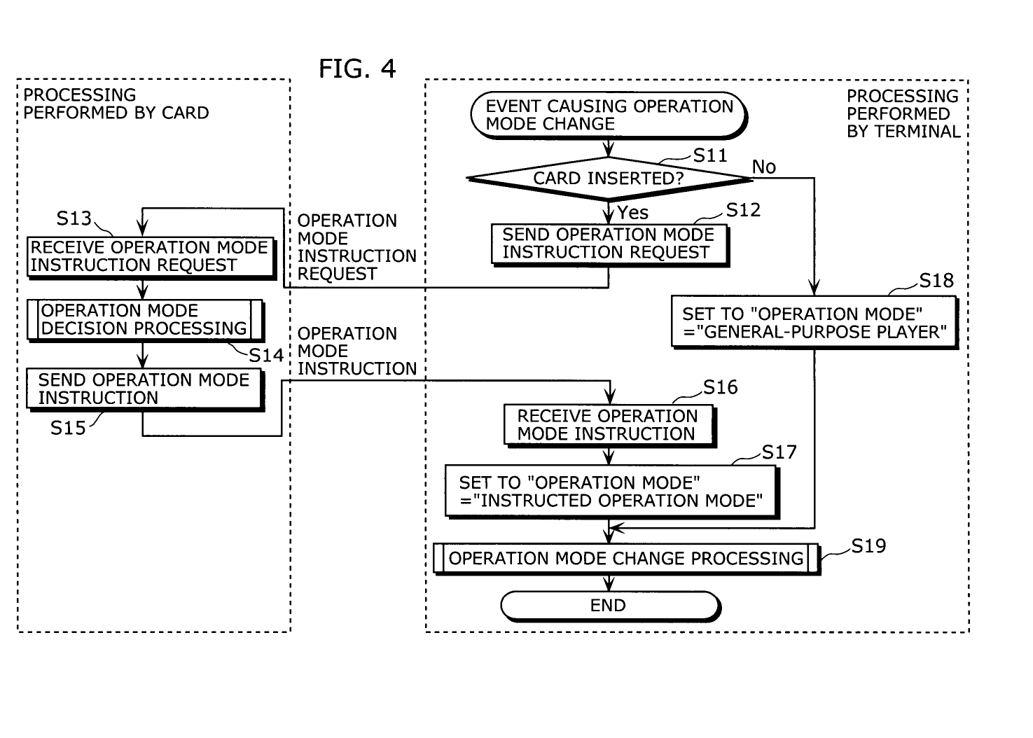

FIG. 4 is a flowchart showing an operation of the operation mode change processing performed between the content reproduction terminal 30a and the card 20a.

The operation mode control unit 303 of the content reproduction terminal 30a starts this operation mode change processing when an operation mode change event occurs, such as activation of the terminal, insertion or withdrawal of the card, or update of the data stored in the card. First, the operation mode control unit 303 judges whether or not the card is being inserted into the IC card slot 31 (S11). When the card is being inserted (Yes in S11), the operation mode control unit 303 sends the operation mode instruction request to the card 20a via the communication unit 301 (S12). This operation mode instruction request refers to a request issued in order to receive the operation mode instruction from the card 20a, and is made up of a message identifier, for example, that shows the present request is an operation mode instruction request.

Receiving the operation mode instruction request via the communication unit 201 (S13), the operation mode decision unit 203a of the card 20a executes operation mode decision processing to generate an operation mode instruction (S14).

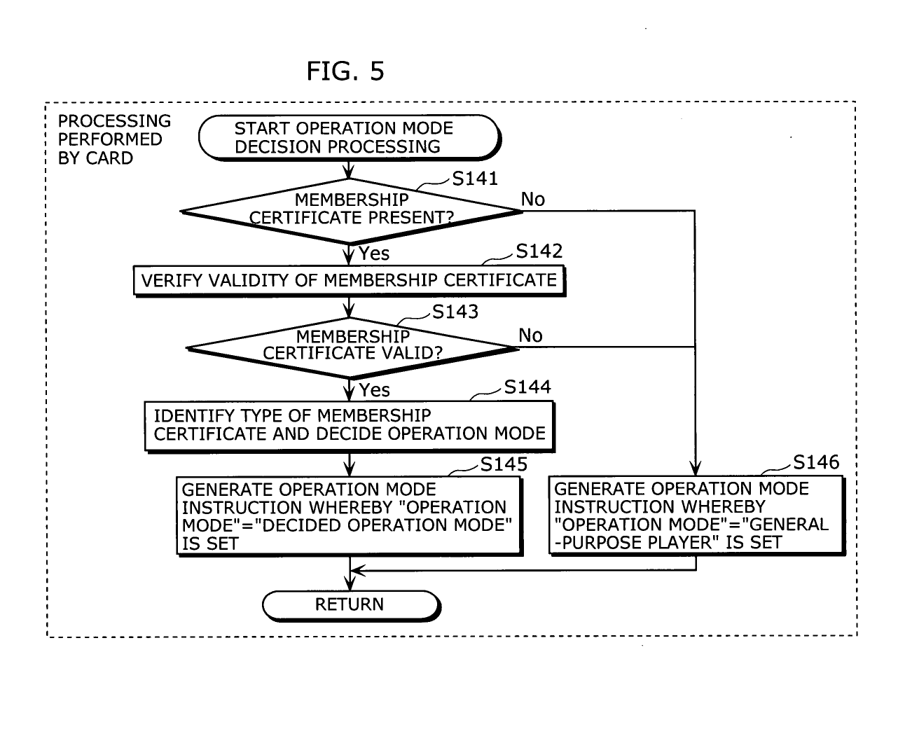

FIG. 5 is a flowchart showing a subroutine of the operation mode decision processing (S14) shown in FIG. 4.

The operation mode decision unit 203a first searches the membership certificate data hold unit 202 and judges whether or not the membership certificate 2020 is present (S141). When the membership certificate 2020 is present (Yes in S141), the operation mode decision unit 203a verifies the validity of the membership certificate 2020 by checking the signature, the expiration date, and so forth (S142), and judges whether or not the membership certificate 2020 is valid (S143).

When the membership certificate 2020 is valid (Yes in S143), the operation mode decision unit 203a identifies the type of the membership certificate and decides the operation mode (S144). Then, the operation mode decision unit 203a generates an operation mode instruction which is an instruction whereby the determined operation mode is set as the operation mode (S145), and returns to the main routine shown in FIG. 4.

On the other hand, when the membership certificate is not present in the membership certificate data hold unit 202 (No in S141) or when the membership certificate is not valid (No in S143), the operation mode decision unit 203a generates an operation mode instruction which is an instruction whereby the mode for the general-purpose player is set as the operation mode (S146), and returns to the main routine shown in FIG. 4.

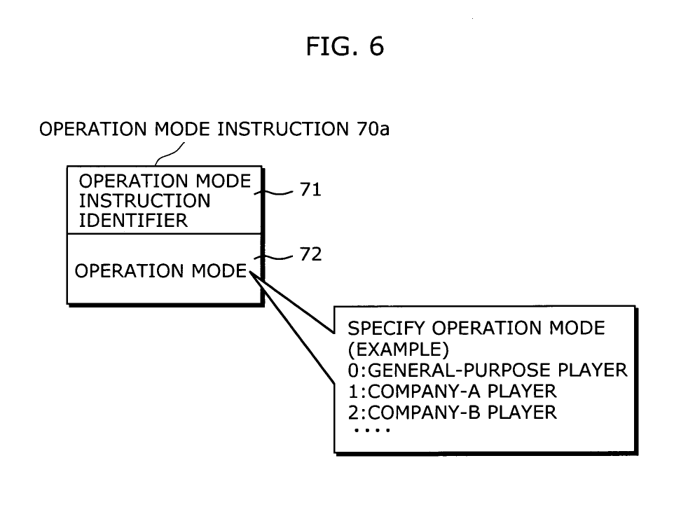

FIG. 6 is a diagram showing an example of a data structure of the above-mentioned operation mode instruction 70a.

As shown in FIG. 6, the operation mode instruction 70a is made up of: an operation mode instruction identifier 71 showing that the present data is an operation mode instruction; and an operation mode 72 showing the details of the present instruction. As the operation mode 72, one of the following is stored: “0” as the general-purpose player; “1” as the player for the members of Company-A; “2” as the player for the members of Company B; and so forth.

After generating the operation mode instruction 70a, the operation mode decision unit 203a sends the generated operation mode instruction 70a to the content reproduction terminal 30a via the communication unit 201 (S15).

Receiving the operation mode instruction 70a via the communication unit 301 (S16), the operation mode control unit 303 of the content reproduction terminal 30a sets the operation mode to the instructed operation mode (S17). Accordingly, the operation mode change processing is executed to change the operation mode of the content reproduction terminal 30a (S19).

On the other hand, when the card is not being inserted (No in S11), the operation mode control unit 303 sets the operation mode for the general-purpose player (S18). Accordingly, the operation mode change processing is executed to change the operation mode of the content reproduction terminal 30a (S19).

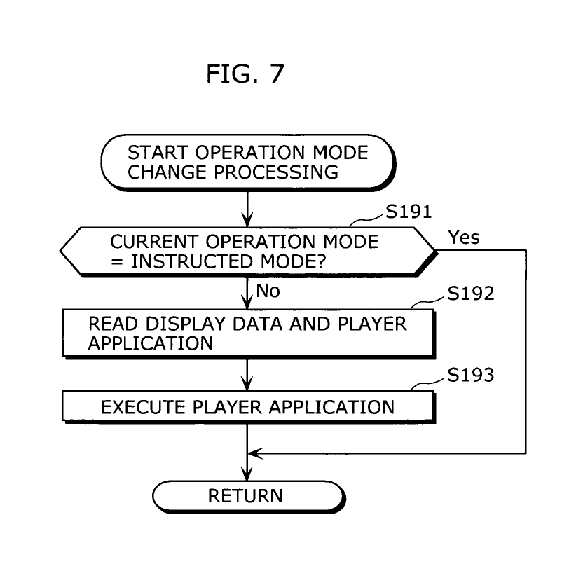

FIG. 7 is a flowchart showing a subroutine of the operation mode change processing (S19) shown in FIG. 4.

First, the operation mode control unit 303 judges whether or not the current operation mode is the instructed mode (S191).

When the current operation mode is the instructed mode (Yes in S191), the operation mode does not need to be changed. Thus, the operation mode control unit 303 returns to the main routine shown in FIG. 4.

When the current operation mode is not the instructed mode (No in S191), the application/display-data acquisition unit 304a reads out the player application and the display data corresponding to the instructed mode from the storage units (S192), and the corresponding application execution unit associated with the instructed mode executes the read player application (S193).

To be more specific, when the current operation mode is set for the general-purpose player while the instructed mode is for the members-only player (of Company A), for example, the application/display-data acquisition unit 304a reads the player application for the members of Company A from the member player application storage unit 309a as well as reading the display data for the members of Company A from the member display data storage unit 310a. Then, the member player application execution unit 308a executes the player application for the members of Company A. Contrary to this, when the current operation mode is for the members-only player while the instructed mode is for the general-purpose player, the application/display-data acquisition unit 304a reads the resident player application from the resident player application storage unit 306a as well as reading the resident display data from the resident display data storage unit 307. Then, the resident player application execution unit 305a executes the resident player application 3060a.

Through this processing, the content reproduction terminal 30a can operate as the general-purpose terminal and as the members-only terminal according to the insertion and withdrawal of the card.

### Second Embodiment

Next, an explanation is given as to a content reproduction terminal of the second embodiment of the present invention.

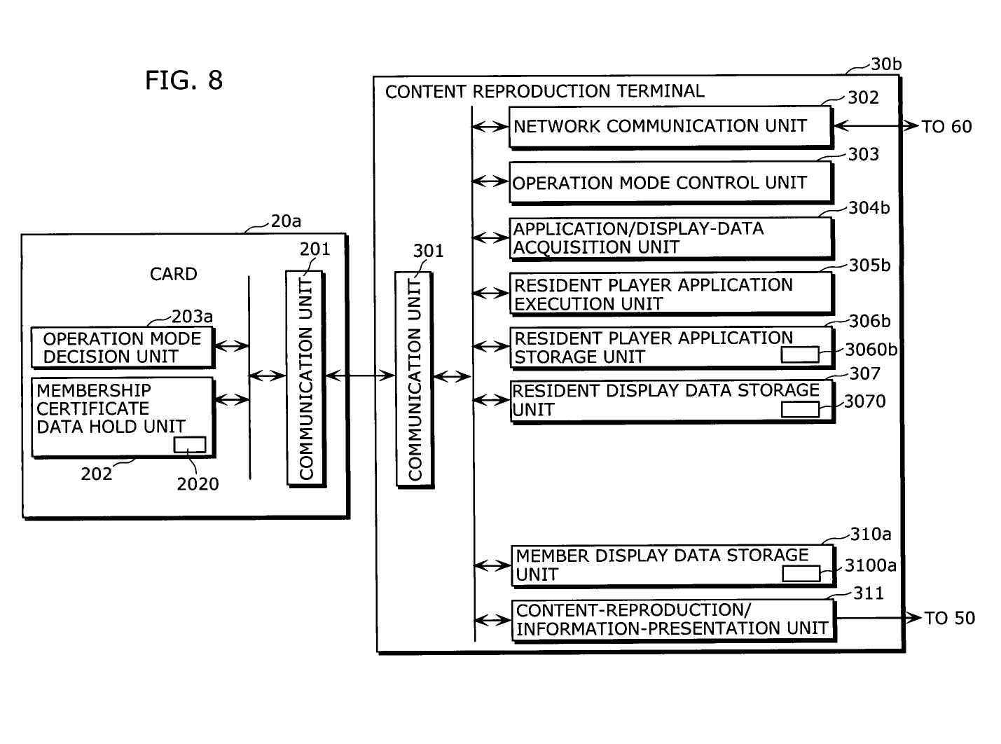

FIG. 8 is a block diagram showing function structures of the content reproduction terminal and a card of the second embodiment of the present invention. It should be noted that the same components as those of the content reproduction terminal 30a and the card 20a are assigned the same numerals as in the first embodiment, and so will not be explained.

The content reproduction terminal 30a of the first embodiment, incidentally, is composed of the member player application execution unit 308a and the member player application storage unit 309a, and is so constructed as to operate as a full-scale members-only terminal. However, according to the circumstances, it is considered that the terminal may adequately differentiate itself if operating as the convenient members-only terminal only by changing its display and GUI.

With this being the case, a content reproduction terminal 30b of the second embodiment has a structure, where the member player application execution unit 308a and the member player application storage unit 309a are omitted whereas a resident player application 3060b switches between the resident display data 3070 and the member display data 3100a in accordance with the operation mode.

To be more specific, the content reproduction terminal 30b is composed of a communication unit 301, a network communication unit 302, an operation mode control unit 303, an application/display-data acquisition unit 304b, a resident player application execution unit 305b, a resident player application storage unit 306b that stores a resident player application 3060b, a resident display data storage unit 307, a member display storage unit 310a, and a content-reproduction/information-presentation unit 311.

In the operation mode change processing performed by the present content reproduction terminal 30b, when the current operation mode is not the instructed mode, the application/display-data acquisition unit 304b reads the display data corresponding to the instructed mode from the storage unit and the resident player application execution unit 305b executes the resident player application 3060b using the display data corresponding to the instructed mode.

More specifically, when the current operation mode is for the general-purpose player while the instructed mode is for the members-only player (of Company A), for example, the application/display-data acquisition unit 304b reads the display data for the members of Company A from the member display data storage unit 310a and the resident player application execution unit 305b executes the resident player application 3060b. That is, the resident player application 3060b uses the member display data 3100a instead of the resident display data 3070. Contrary to this, when the current operation mode is for the members-only player while the instructed mode is for the general-purpose player, the application/display-data acquisition unit 304b reads the resident display data 3070 from the resident display data storage unit 307 and the resident player application execution unit 305b executes the resident player application 3060b. That is, the resident player application 3060b uses the resident display data 3070 instead of the member display data 3100a.

Through this processing also, the content reproduction terminal 30b can operate as the general-purpose terminal and as the members-only terminal according to the insertion and withdrawal of the card 20a.

### Third Embodiment

Next, an explanation is given as to a content reproduction terminal of the third embodiment of the present invention.

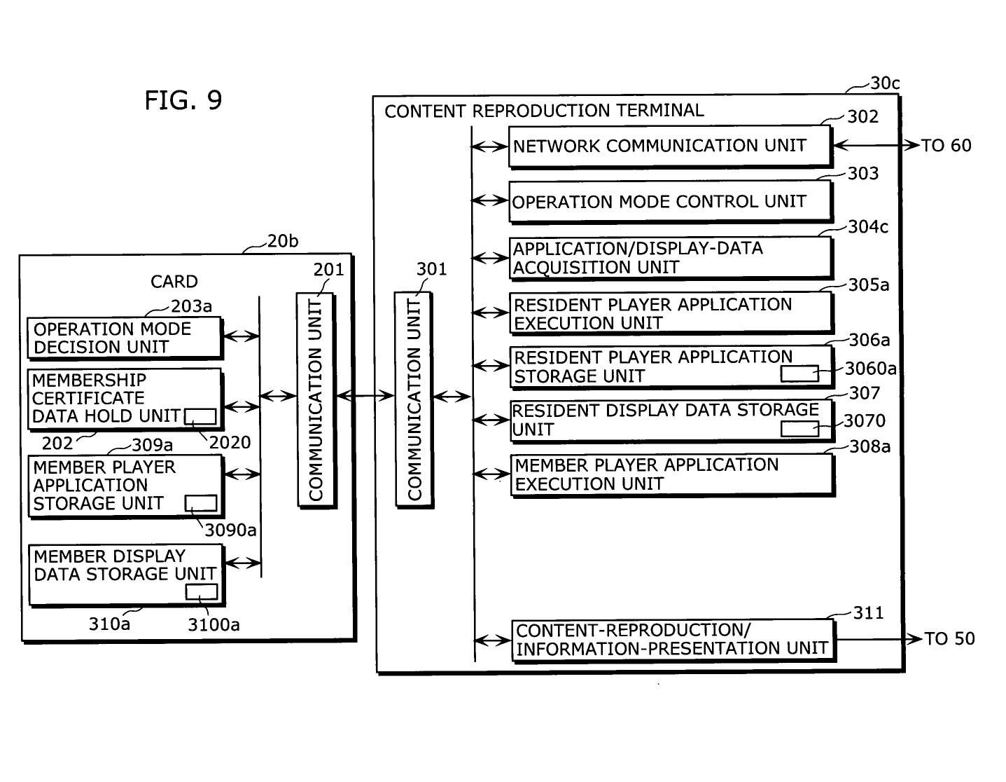

FIG. 9 is a block diagram showing function structures of the content reproduction terminal and a card of the third embodiment of the present invention. It should be noted that the same components as those of the content reproduction terminal 30a and the card 20a are assigned the same numerals as in the first embodiment, and so will not be explained.

The content reproduction terminal 30a of the first embodiment, incidentally, is composed of the member player application storage unit 309a and the member display data storage unit 310a, and is so constructed as to acquire the member player application 3090a and the member display data 3100a via the network 60. However, according to the circumstances, there may be a case where the card is composed of the member player application storage unit 309a and the member display data storage unit 310a and is so constructed as to previously store the member player application 3090a and the member display data 3100a.

With this being the case, a content reproduction terminal 30c of the third embodiment has a structure, where the member player application storage unit 309a and the member display data storage unit 310a are omitted. In the case of the members-only operation mode, the application/display-data acquisition unit 304c acquires the member player application 3090a and the member display data 3100a from the member player application storage unit 309a and the member display data storage unit 310 provided for the card 20b, and the member player application execution unit 308a executes the member player application 3090a.

More specifically, the card 20b is further composed of a member player application storage unit 309a and a member display data storage unit 310a in addition to a communication unit 201, a membership certificate data storage unit 202, and an operation mode decision unit 203a. To be more specific, the member player application storage unit 309a and the member display data storage unit 310a are provided for the card 20b when the card 20b is issued, so that the member player application 3090a and the member display data 3100a are respectively stored into the member player application storage unit 309a and the member display data storage unit 310a.

The content reproduction terminal 30c is composed of a communication unit 301, a network communication unit 302, an operation mode control unit 303, an application/display-data acquisition unit 304c, a resident player application execution unit 305a, a resident player application storage unit 306a, a resident display data storage unit 307, a member player application execution unit 308a, and a content-reproduction/information-presentation unit 311.

For the operation mode change processing performed by the present content reproduction terminal 30b, suppose that the current operation mode is not the instructed mode, i.e., suppose that the current operation mode is for the general-purpose player while the instructed mode is for the members-only player (of Company A), for example. In this case, the application/display-data acquisition unit 304c reads the member player application 3090a from the member player application storage unit 309a of the card 20b via the communication units 201 and 301 as well as reading the display data for the members of Company A from the member display data storage unit 310a via the communication units 201 and 301. Then, the member player application execution unit 308a executes the member player application 3090a.

Through this processing also, the content reproduction terminal 30c can operate as the general-purpose terminal and as the members-only terminal according to the insertion and withdrawal of the card 20b.

### Fourth Embodiment

Next, an explanation is given as to a content reproduction terminal of the fourth embodiment of the present invention.

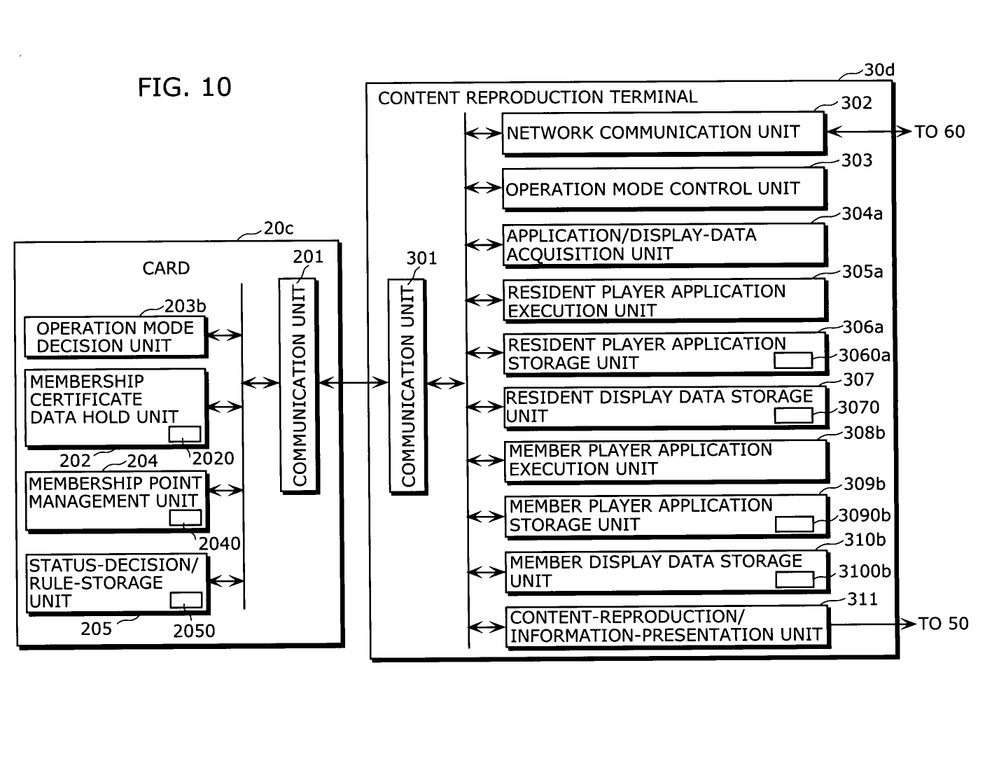

FIG. 10 is a block diagram showing function structures of the content reproduction terminal and a card of the fourth embodiment of the present invention. It should be noted that the same components as those of the content reproduction terminal 30a and the card 20a are assigned the same numerals as in the first embodiment, and so will not be explained.

In the first embodiment, incidentally, when the user is a member, all the members were given the same status and the member display data and the member player application are executed in the same way for all the members. However, there is management whereby according to the purchase amount or the rental amount of content, the user is given points which are to be recorded into a card and then a status, such as a silver member or a gold member with a corresponding discount rate, is granted according to the point value. As such, there may be a case where the member display data and the member player application are changed in accordance with the status.

With this being the case, a content reproduction terminal 30d of the fourth embodiment is so constructed as to change the operations of the member player application execution unit 308b, the member player application storage unit 309b, and the member display data storage unit 310b in the case of the members-only operation mode in accordance with the status corresponding to the point value of the member.

To be more specific, in addition to a communication unit 201, a membership certificate data hold unit 202, and an operation mode decision unit 203b, the card 20b is further composed of a membership point management unit 204 that manages a membership point value 2040 and a status-decision/rule-storage unit 205 that stores a rule 2050 used in a decision of the membership status.

In the operation mode decision processing, the operation mode decision unit 203b decides the status based on the membership point value 2040 managed by the membership point management unit 204 and on the rule 2050 stored in the status-decision/rule-storage unit 205 and generates an operation mode instruction, as well as deciding the operation mode.

The content reproduction terminal 30d is composed of a communication unit 301, a network communication unit 302, an operation mode control unit 303, an application/display-data acquisition unit 304a, a resident player application execution unit 305a, a resident player application storage unit 306a, a resident display data storage unit 307, a member player application execution unit 308b, a member player application storage unit 309b, a member display data storage unit 310b, and a content-reproduction/information-presentation unit 311.

The member display data storage unit 310b stores the member display data 3100b corresponding to the status.

The member player application storage unit 309b stores the member player application 3090b corresponding to the status.

In the operation mode change processing, the application/display-data acquisition unit 304a acquires the member display data 3100b and the member player application 3090b that is stored in the member player application storage unit 309b corresponding to the status, in accordance with the operation mode instruction.

The member player application execution unit 308b executes the member player application 3090b acquired by the application/display-data acquisition unit 304a.

Next, an explanation is given as to an operation of the operation mode decision processing performed by the card 20c.

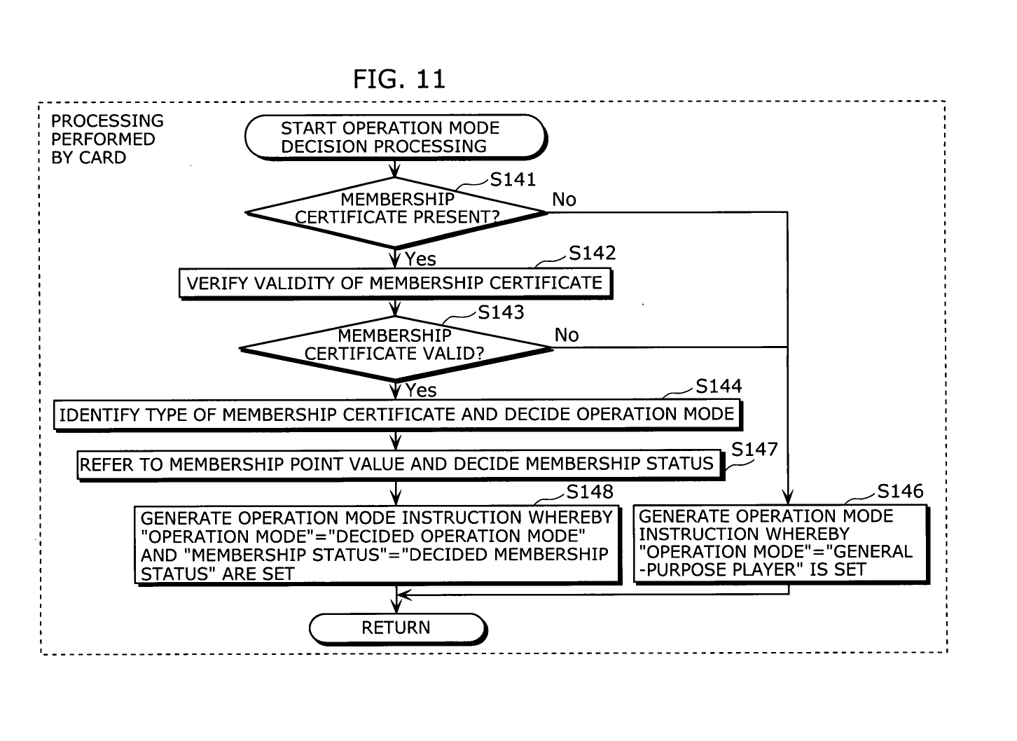

FIG. 11 is a flowchart showing a subroutine of the operation mode decision processing (S14) shown in FIG. 4. It should be noted that the same step numbers as in the flowchart of FIG. 5 are assigned to the corresponding parts.

The operation mode decision unit 203b first searches the membership certificate data hold unit 202 and judges whether or not the membership certificate 2020 is present (S141). When the membership certificate 2020 is present (Yes in S141), the operation mode decision unit 203b verifies the validity of the membership certificate 2020 by checking the signature, the expiration date, and so forth (S142), and judges whether or not the membership certificate 2020 is valid (S143).

When the membership certificate 2020 is valid (Yes in S143), the operation mode decision unit 203b identifies the type of the membership certificate and decides the operation mode (S144). Then, the operation mode decision unit 203b refers to the membership point value 2040 stored in the membership point management unit 204 and decides the membership status in accordance with the rule 2050 stored in the status-decision/rule storage unit 205 (S147). After deciding the operation mode and the membership status, the operation mode decision unit 203b generates an operation mode instruction which is an instruction whereby the decided operation mode is set as the operation mode and the decided membership status is set as the membership status (S148), and returns to the main routine shown in FIG. 4.

On the other hand, when the membership certificate is not present in the membership certificate data hold unit 202 (No in S141) or when the membership certificate is not valid (No in S143), the operation mode decision unit 203b generates an operation mode instruction which is an instruction whereby the operation mode is set for the general-purpose player (S146), and returns to the main routine shown in FIG. 4.

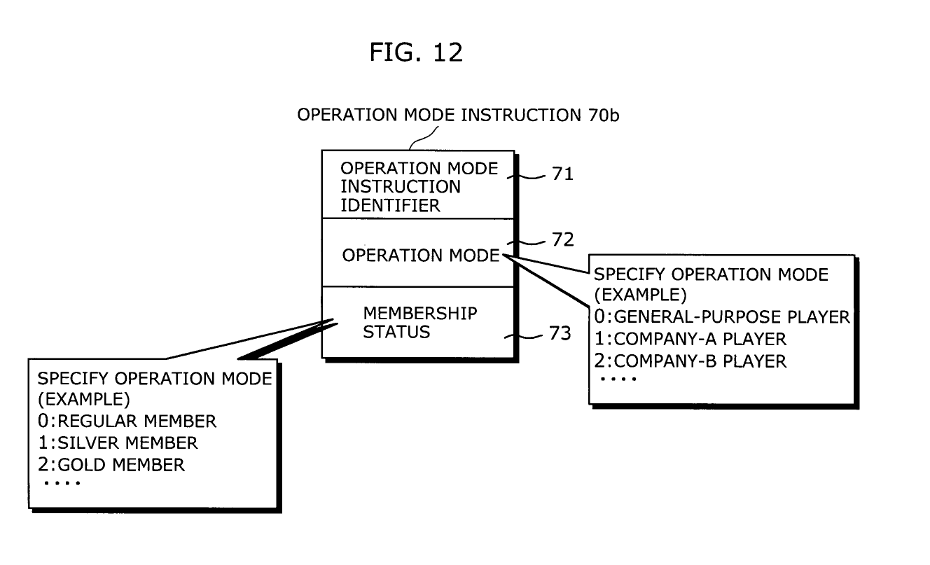

FIG. 12 is a diagram showing an example of a data structure of the above-mentioned operation mode instruction 70b.

As shown in FIG. 12, the operation mode instruction 70b is made up of: an operation mode instruction identifier 71 showing that the present data is an operation mode instruction; an operation mode 72 showing the details of the present instruction; and a membership status 73 showing the status of the member. As the membership status 73, one of the following is stored: “0” as a regular member; “1” as a silver member; “2” as a gold member; and so forth.

After generating the operation mode instruction 70b, the operation mode decision unit 203b sends the generated operation mode instruction 70b to the content reproduction terminal 30d via the communication unit 201.

In the operation mode change processing, the application/display-data acquisition unit 304a of the content reproduction terminal 30d acquires the member display data 3100b and the member player application 3090b that is stored in the member player application storage unit 309b corresponding to the status, in accordance with the operation mode instruction. Then, the member player application execution unit 308b executes the member player application 3090b acquired by the application/display-data acquisition unit 304a.

Moreover, the decoration and the GUI can be changed according to the membership status.

This processing not only allows the content reproduction terminal 30d to operate as the general-purpose terminal and as the members-only terminal according to the insertion and withdrawal of the card 20c, but also allows the decoration and the GUI to be changed according to the membership status.

In the above first to fourth embodiments, the operation mode decision units 203a and 203b are provided for the corresponding cards 20a to 20c. However, the units 203a and 203b may be provided for the corresponding content reproduction terminals 30a to 30d.

Moreover, in the above first to fourth embodiments, the decorative display and the GUI display are changed in the members-only mode. However, a button to access the server 10 may be displayed in the members-only mode. By pressing this button, the user may access a site provided by the present server 10, such as “Commentary on Content by Uncle Niginigi” and may download content such as “Fishing—untold production story behind Δ□×◯”. Alternatively, by pressing this button, the user may access a site provided by the present server 10, such as “Upgrade of Content” and may download data to have the sound of the content into the 5.1ch audio format or data to have the image quality of the content in the high density equivalent to the theatrical version.

### Fifth Embodiment

Next, an explanation is given as to a content reproduction terminal of the fifth embodiment of the present invention.

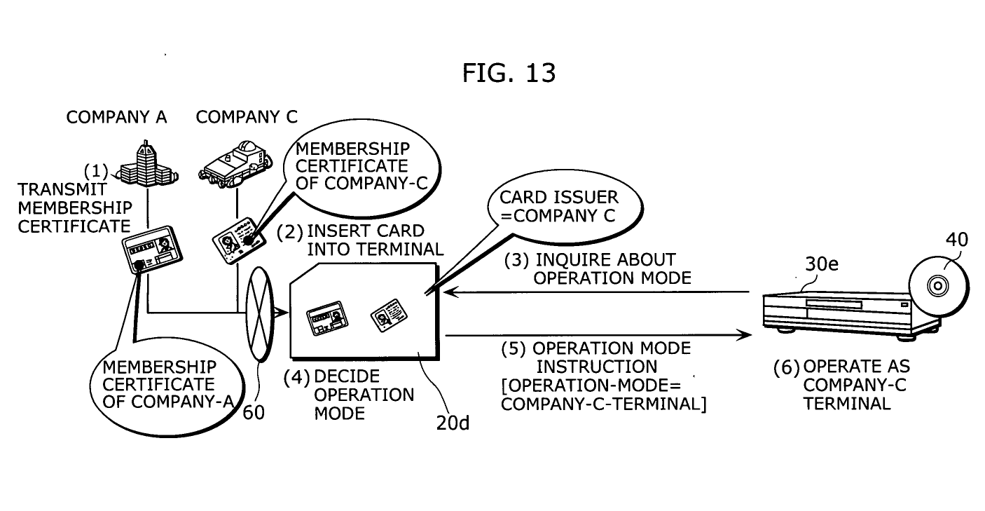

FIG. 13 is a diagram showing an entire structure of a membership system applied to the content reproduction terminal of the fifth embodiment of the present invention.

In the above first to fourth embodiments, incidentally, only one membership certificate is stored in the card 20a. If the card can store only one membership certificate in this way, a card is sent every time the user becomes a member. Thus, the number of the cards increases every time the user signs up, making the management of the cards burdensome. For this reason, consideration may be given to a case where a plurality of membership certificates are stored into one card. T6 be more specific, when the user becomes a member of a provider (Company C, for example), the membership service provider Company C stores membership certificate data before issuing a card 20d to the user who signed up for the membership. Then, when the user becomes a member of another provider (Company A, for example), a membership certificate of Company A may be only transmitted to be added to the card 20d. Here, in this case, the management of the card becomes easier. Nevertheless, it is complicated if the user has to be bothered to choose one of the plurality of the certificates.

With this being the case, the content reproduction terminal 30e of the fifth embodiment includes a mechanism for specifying the membership certificate to which priority should be given when a plurality of membership certificates are present in the card, in addition to the functions of the content reproduction terminal 30a in the first embodiment.

To be more specific, when the user inserts the card 20d storing a plurality of membership certificates into a card slot of the content reproduction terminal 30e, the content reproduction terminal 30e inquires of the card 20d at a predetermined timing about which operation mode (i.e., a mode for which company's members-only terminal) should be selected. The card 20d decides upon the operation mode indicating the mode for the certain members-only terminal in which the terminal should operate, and specifies the decided operation mode (operation-mode=Company-C-terminal, for example). Then, the content reproduction terminal 30e operates as the Company-C terminal as instructed.

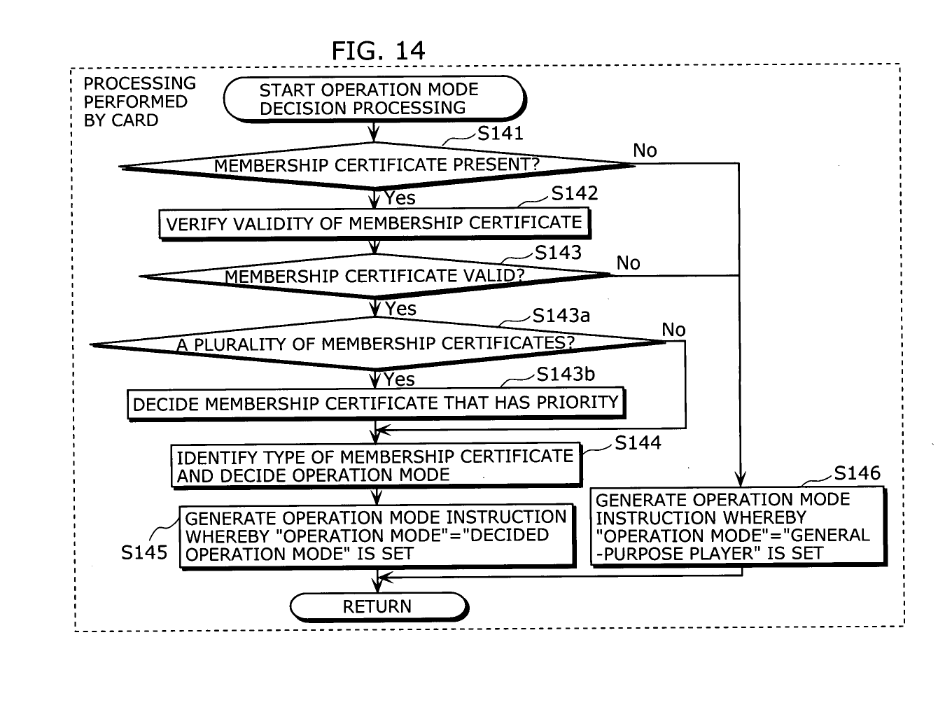

FIG. 14 is a flowchart showing a subroutine of the operation mode decision processing (S14) shown in FIG. 4. It should be noted that the same step numbers as in the flowchart of FIG. 5 are assigned to the corresponding parts, and the detailed explanations are omitted.

The operation mode decision unit 203a first searches the membership certificate data hold unit 202 and judges whether or not the membership certificate 2020 is present (S141). When the membership certificate 2020 is present (Yes in S141), the operation mode decision unit 203a verifies the validity of the membership certificate 2020 by checking the signature, the expiration date, and so forth (S142), and judges whether or not the membership certificate 2020 is valid (S143).

When the membership certificate 2020 is valid (Yes in S143), the operation mode decision unit 203a judges whether or not a plurality of valid membership certificates are present (S143a). When a plurality of certificates are not present (No in S143a), that is, when only one certificate is present, the operation mode decision unit 203a identifies the type of the membership certificate and decides the operation mode as is the case with the first embodiment (S144). Then, the operation mode decision unit 203a generates an operation mode instruction which is an instruction whereby the decided operation mode is set as the operation mode (S145), and returns to the main routine shown in FIG. 4.

On the other hand, when a plurality of the membership certificates are present (Yes in S143a), the operation mode decision unit 203a decides a membership certificate out of the plurality of certificates that has priority over the others (S143b), identifies the type of the decided membership certificate, and decides the operation mode (S144). Then, the operation mode decision unit 203a generates an operation mode instruction which is an instruction whereby the decided operation mode is set as the operation mode (S145), and returns to the main routine shown in FIG. 4.

As the method of deciding upon the membership certificate to which priority is given in step S143b, there are:

A) a method whereby a flag is previously set to a membership certificate of the highest priority so that priority is placed on the membership certificate with the flag;

B) a method whereby an order of priority is previously set for the membership certificates so that priority is placed on the membership certificate of the highest priority;

C) a method whereby a content usage history for a period of time, such as over the past month or week, is held so that priority is placed on a membership certificate of the provider (Company A, for example) which provides the content that has been used with a high frequency; and

D) a method whereby card issuer information is previously set in the card and when the membership certificate issued by the card issuer is present, priority is placed on the present membership certificate (in the case of the example shown in FIG. 13, when the card is issued by Company C, priority is placed on the membership certificate of Company C).

It should be noted that in the cases of A) and B), the setting is previously carried out in accordance with the instruction from the user.

In this way, the membership certificate of the highest priority is automatically determined out of a plurality of the membership certificates. Thus, the content reproduction terminal 30e can operate as a predetermined members-only terminal without causing any inconvenience to the user.

Moreover, when the method described in C) is employed, the membership certificate may be dynamically changed in accordance with the content usage history.

Note that the content reproduction terminal 30e may be composed of a plurality of card slots 31, so that various kinds of cards 20d can be inserted into these card slots 31. In this case, the content reproduction terminal 30e may decide upon the membership certificate with the highest priority according to the method described in A), B), or C).

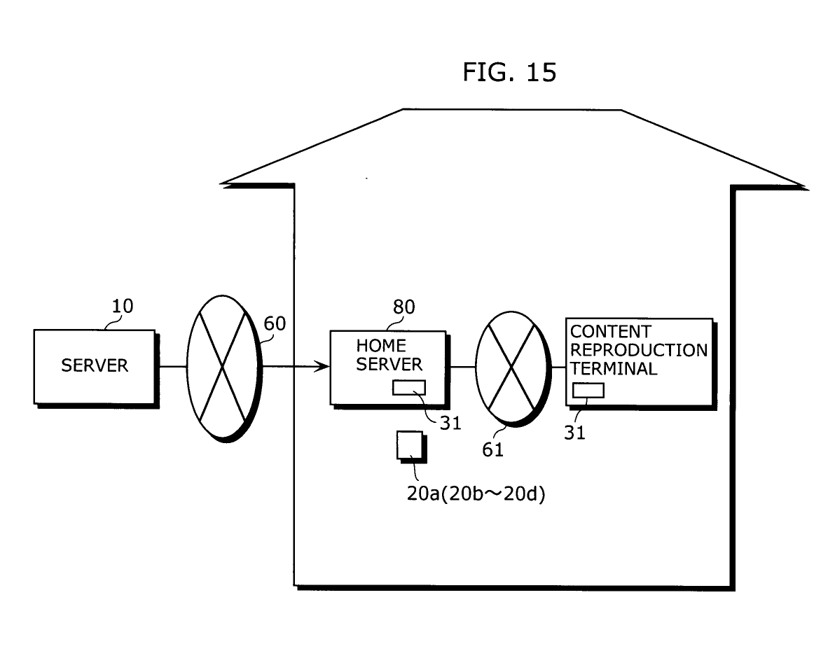

Furthermore, the following is possible in a case where the content reproduction terminal is connected to a home server 80 via a home LAN 61 and the card 20d is inserted into the card slot 31 of the home server 80 at home as shown in FIG. 15. When the card 20d is not being inserted into the card slot 31 of the content reproduction terminal, the content reproduction terminal may inquiry of the card 20a (20b to 20d) of the home server 80 via the home LAN 61 at a predetermined timing about which operation mode (i.e., a mode for which company's members-only terminal) should be selected. The card 20a (20b to 20d) decides upon the operation mode indicating the mode for the certain members-only terminal in which the terminal should operate, and specifies the decided operation mode (operation-mode=Company-C-terminal, for example). Then, the content reproduction terminal 30e operates as the Company-C terminal as instructed.

In this way also, the content reproduction terminal 30e can operate as the predetermined members-only terminal without causing any inconvenience to the user.

### Sixth Embodiment

Next, an explanation is given as to a content reproduction terminal of the sixth embodiment of the present invention.

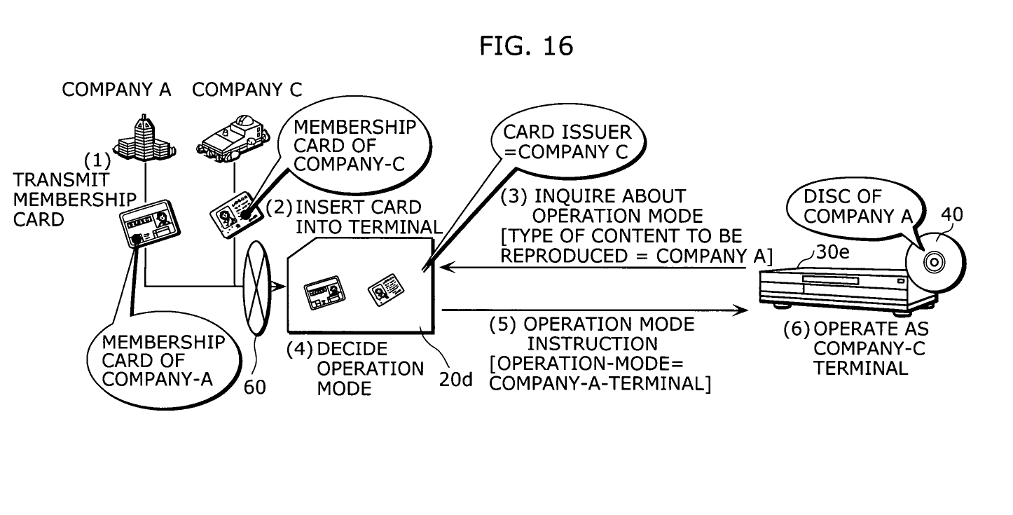

FIG. 16 is a diagram showing an entire structure of a membership system applied to the content reproduction terminal of the sixth embodiment of the present invention.

In the fifth embodiment, incidentally, as the mechanism to place priority on the membership certificate, the following methods were applied:

A) a method whereby a flag is previously set to a membership certificate of the highest priority so that priority is placed on the membership certificate with the flag;

B) a method whereby an order of priority is previously set for the membership certificates so that priority is placed on the membership certificate of the highest priority;

C) a method whereby a content usage history for a period of time, such as over the past month or week, is held so that priority is placed on a membership certificate of the provider (Company A, for example) which provides the content that has been used with a high frequency; and

D) a method whereby card issuer information is previously set in the card and when the membership certificate issued by the card issuer is present, priority is placed on the present membership certificate (in the case of the example shown in FIG. 13, when the card is issued by Company C, priority is placed on the membership certificate of Company C).

Using these methods, however, there is hardly any connection with content. For instance, while the content of Company A is being reproduced, the content reproduction terminal 30e may operate as the Company-C terminal. This is unfavorable for the issuer of the membership certificate as well as for the user.

With this being the case, the content reproduction terminal 30e of the sixth embodiment includes a mechanism for changing the operation mode in accordance with a disc/content to be reproduced.

To be more specific:

1. The membership service provider transmits the membership certificate data to the user who signed up for the membership.

2. The user inserts the card into the card slot of the terminal.

3. The terminal inquires of the card at a predetermined timing (such as when the terminal is activated or when the card is inserted) about which operation mode should be selected. This inquiry includes the type of disc/content to be reproduced.

4. The card decides the operation mode on the basis of the information inside the card (the priority of the membership certificate, the presence/absence of the membership certificate, the status of the member, and information as to the expiration date, etc.) and on the basis of the type of disc/content transmitted from the terminal. To be more specific, the operation mode decision unit decides the operation mode, giving more consideration to the kind of the content provider (such as Company A or Company C) included in the type of disc/content than to the mechanism described in above A) to D) for placing the priority to the membership certificates. For example, when the content provider is Company A and the card has the valid membership certificate of Company A, the operation mode is decided for the Company-A terminal.

5. The card sends the decided operation mode (for the Company-A terminal) to the terminal.

6. The terminal operates in accordance with the instruction from the card.

Accordingly, the terminal can operate as the members-only terminal corresponding to the content. This is more favorable to the issuer of the membership certificate and the user.

It should be noted that the disc/content information included in the inquiry made by the content reproduction terminal 30e about the operation mode may include a rating, such as an 18 rating, and a genre, such as sport, drama, movie, or education. In this case, the card may include these rating and genre into the decided operation mode, and the content reproduction terminal 30e may change the decoration according to these rating and genre.

Thus, when the rating is the 18 rating, for example, the decoration can be made for adults.

Moreover, an IC tag may be affixed to the package of the content so that a tag reader can read the distribution form (for sale or for rental, for instance) of the disc recorded in the IC tag. Then, the read distribution form may be included in the disc/content information, and the card may decide the operation mode on the basis of the distribution form. However, it does not always have to be an IC tag. When the distribution form of the disc can be read from the physical shape of the disc or from the information recorded in the disc, the distribution form read from these may be included in the disc/content information so that the operation mode can be decided on the basis of the distribution form.

Thus, when the distribution form indicates that it is for rental, for example, the terminal can operate as the members-only terminal for Rental Company B even if the content is from Company A.

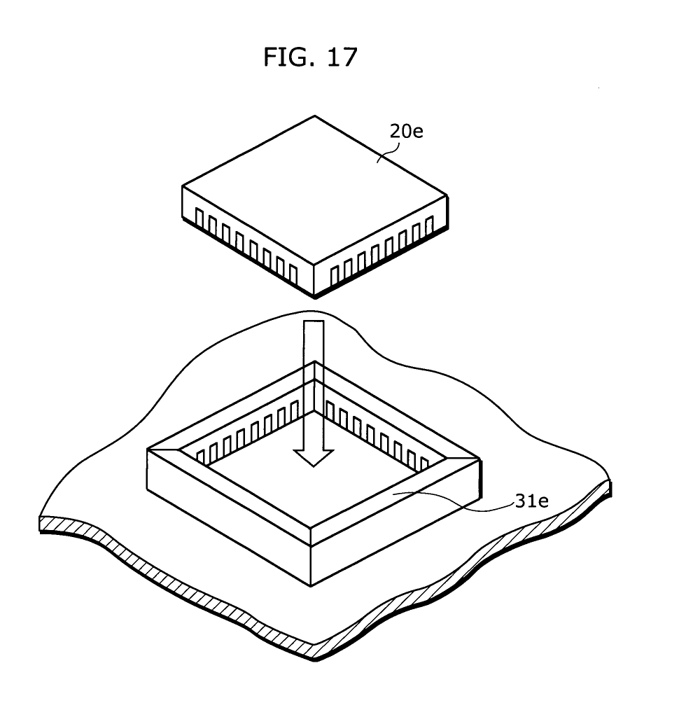

In the above first to sixth embodiments, the explanation has been given as to a case where a function as the members-only terminal is realized using a transportable card as a secure device. However, this function may be realized in the terminal. In this case, as shown in FIG. 17, an IC chip 20e may be used in place of the card. The IC chip 20e may be fixed to a circuit board using a socket 31e. Alternatively, it may be realized by software on a personal Computer (PC) (in this case, it is preferable to be tamper resistant). In this case, the data of the membership certificate or the like may be stored when the membership sing-up is carried out.

Furthermore, the explanation has been given as to a case where content is recorded in a disc. However, it is not limited to this, and the content may be obtained through a broadcast or the Internet. Then, the terminal may fulfill its function as the members-only terminal for the content.

### INDUSTRIAL APPLICABILITY

The content reproduction terminal of the present invention can be applied to a content reproduction terminal, such as a DVD player, which can be transformed into a members-only terminal when a user inserts a membership card into an IC card slot of the content reproduction terminal.

1. A content reproduction terminal for reproducing content, comprising:
a terminal body; and
a secure device to be placed in said terminal body,
wherein said secure device includes
a membership information hold unit operable to hold membership information which is distributed to a membership user and indicates a group to which the user belongs, and
said terminal body includes:
an operation mode setting unit operable to set an operation mode on the basis of the membership information held by said membership information hold unit; and
a reproduction unit operable to reproduce the content differently depending on the setting result given by said operation mode setting unit.

2. The content reproduction terminal according to claim 1,
wherein said reproduction unit has:
a first storage unit operable to store a first application program for reproducing the content in a members-only operation mode;
a second storage unit operable to store a second application program for reproducing the content in a non-member operation mode;
a selection unit operable to select one of the first application program and the second application program in accordance with the setting result; and
an execution unit operable to execute the application program selected by the selection unit to reproduce the content,
wherein the first application program is operable to cause said execution unit to execute a members-only decorative display.

3. The content reproduction terminal according to claim 2,
wherein the first application program is further operable to cause said execution unit to execute a members-only graphical user interface display.

4. The content reproduction terminal according to claim 1,
wherein said reproduction unit has:
a storage unit operable to store an application program for reproducing the content;
a selection unit operable to select one of first display data and second display data in accordance with the setting result; and
an execution unit operable to execute the application program to reproduce the content using the selected display data,
wherein the first display data is used for a members-only decorative display, and
the second display data is used for a non-member undecorative display.

5. The content reproduction terminal according to claim 4,
wherein the first display data further includes a members-only graphical user interface data.

6. The content reproduction terminal according to claim 1,
wherein said secure device further includes
a first storage unit operable to store a first application program for reproducing the content in a members-only operation mode, and
said reproduction unit has:
a second storage unit operable to store a second application program for reproducing the content in a non-member operation mode;
a selection unit operable to select one of the first application program and the second application program in accordance with the setting result; and
an execution unit operable to execute the application program selected by the selection unit to reproduce the content,
wherein the first application program is operable to cause said execution unit to execute a members-only decorative display.

7. The content reproduction terminal according to claim 1,
wherein said terminal body further includes
an operation mode inquiry unit operable to inquire of said secure device about which operation mode is to be selected, and
said secure device further includes
an operation mode instruction unit operable to, when the inquiry is received, decide the operation mode on the basis of the membership information and to instruct said terminal body to operate in the decided operation mode,
wherein said operation mode setting unit is operable to set the operation mode on the basis of the instruction as to the operation mode decided by the operation mode instruction unit.

8. The content reproduction terminal according to claim 7,
wherein said membership information hold unit is operable to hold a plurality of sets of membership information, and
said operation mode instruction unit is operable to, when the inquiry is received, decide the operation mode including a set of membership information that is to be prioritized out of the plurality of sets of membership information.

9. The content reproduction terminal according to claim 8,
wherein the inquiry includes content information regarding the content to be reproduced, and
said operation mode instruction unit is operable to, when the inquiry is received, decide the operation mode including the set of membership information to be prioritized out of the plurality of sets of membership information, on the basis of the content information included in the inquiry.

10. The content reproduction terminal according to claim 1,
wherein said terminal body further includes
an operation mode inquiry unit operable to inquire of said secure device about which operation mode is to be selected, and
said secure device includes:
a membership point storage unit operable to store a membership point given to the user;
a rule storage unit operable to store a rule as to a membership status granted to the user according to a value of the membership point; and
an operation mode instruction unit operable to, when the inquiry is received, decide the operation mode and the membership status on the basis of the membership information, the membership point, and the rule, and to instruct said terminal body as to the decided operation mode and the decided membership status,
wherein said operation mode setting unit is operable to set he operation mode on the basis of the instruction as to the operation mode and the membership status decided by the operation mode instruction unit.

11. The content reproduction terminal according to claim 1,
wherein said secure device is an IC card,
said terminal body further includes an IC card slot into which said IC card is to be inserted, and
said operation mode setting unit is operable to set the operation mode on the basis of an insertion state of said IC card with respect to said IC card slot.

12. A content reproduction method used by a content reproduction terminal comprising a terminal body and a secure device to be placed in the terminal body, said method comprising:
a membership information hold step of holding membership information which is distributed to a membership user and indicates a group to which the user belongs, in the secure device;
an operation mode setting step of setting an operation mode on the basis of the membership information held in said membership information hold step, in the terminal body; and
a reproduction step of reproducing the content differently depending on the setting result of said operation mode setting step, in the terminal body.

13. A program causing a computer to execute said steps included in the content reproduction method described in claim 12.
